(19) United States
(12) Patent Application Publication
(10) Pub. No.: US 2026/0349698 A1
(43) Pub. Date: Nov. 5, 2026

(54) VEHICLE ECOSYSTEM

(71) Applicant: MERCEDES-BENZ GROUP AG, Stuttgart (DE)

(72) Inventors: Viktor FRIESEN, Karlsruhe (DE); Micha KOLLER, Fellbach (DE); Hubert REHBORN, Sindelfingen (DE)

(21) Appl. No.: 19/136,607

(22) PCT Filed: Nov. 26, 2023
(86) PCT No.: PCT/EP2023/083083

§ 371 Date: Jun. 6, 2025

(30) Foreign Application Priority Data
Dec. 9, 2022 (DE) 10 2022 004 604.0

(51) Int. Cl. G06F 8/65

(52) U.S. Cl. CPC G06F 8/65

(57) ABSTRACT

A vehicle ecosystem includes a central computing device and a vehicle fleet formed of vehicles. The central computing device obtains a development order or initiate one itself, creates a development data packet, and distribute this to a first set of vehicles of the vehicle fleet. The central computing device controls the first set of vehicles to execute the development data packet. The vehicles record user interaction information obtained during an interaction process and to transmit this to the central computing device. The central computing device processes the user interaction information, creates an introduction data packet based on the knowledge gained therefrom, and distributes distribute the introduction data packet to a second set of vehicles of the vehicle fleet and respectively execute it there for implementation.

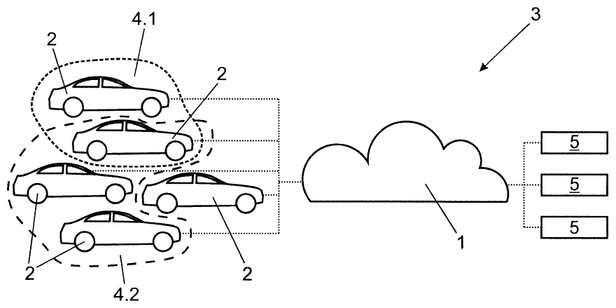

### BACKGROUND AND SUMMARY OF THE INVENTION

Exemplary embodiments of the invention relate to a vehicle ecosystem.

Vehicle occupants can become bored during a journey in a vehicle. This is particularly the case when the vehicle is stopped in traffic or congestion. It is also expected that boring situations will occur more frequently with increasing levels of automatization, as the person driving the vehicle has to spend less or no attention on the driving process. Thus, there is the need to distract or entertain vehicle occupants during the use of their vehicle.

In general, platforms are known for delivering microjobs. People who pursue such an activity are also referred to as clickworkers. Providing access to such microjobs via the internet is also referred to as crowdsourcing. The most widely known providers of such platforms are Amazon Web Services, Inc. having the platform Mechanical Turk, also known as mturk, and Clickworker. de in the German-speaking world. Comparatively simple and short assignments can be accepted and processed via such a platform, such as performing proofreading, answering questionnaires, verifying AI learning data and similar. In addition to money, workers are usually paid in the form of vouchers.

Furthermore, vehicle manufacturers are always striving to further develop their vehicles, so that a higher level of reliability and in particular customer satisfaction is achieved.

DE 10 2014 204 227 A1 discloses an AD manager for a vehicle multi-media system. The AD manager collects context-related data accruing during vehicle usage and enables the provision of advertisements in the vehicle, which adapt to the corresponding context. In this case, a request is also provided to a user for interaction. Based on the received user input, a further set of display components is then output.

Carrying out surveys in a vehicle is also known from U.S. Pat. No. 10,636,046 B2.

Exemplary embodiments of the present invention are directed to an improved vehicle ecosystem that helps the vehicle manufacturer to further develop their vehicles.

A generic vehicle ecosystem, comprising a central computing device and a vehicle fleet, wherein the vehicles of the vehicle fleet are in bidirectional communication with the central computing device and are set up such that their configuration can be changed by receiving information from the central computing device, is refined according to the invention in that
the central computing device is set up to obtain a development order or initiate one itself, wherein the development order at least describes which vehicle component is to be further developed;
the central computing device is also set up to create a development data packet based on the development order and distribute this to a first set of vehicles of the vehicle fleet, wherein the development data packet at least comprises interaction information and optionally configuration information, wherein the interaction information describes a predefined interaction process with vehicle occupants via a human-machine interface and the configuration information contains information for introducing a new and/or for changing an existing vehicle functionality that is based on software;
the central computing device is also set up to control the first set of vehicles of the vehicle fleet for executing the development data packet, wherein at least one vehicle functionality and the interaction process are executed in each of the vehicles based on the interaction information and optionally at least one vehicle configuration concerning the vehicle functionality is changed based on the configuration information, wherein the vehicles are set up to record user interaction information obtained during the interaction process and to transmit this to the central computing device;
the central computing device is also set up to process the user interaction information obtained from the first set of vehicles of the vehicle fleet and to create an introduction data packet based on the knowledge gained therefrom, wherein the introduction data packet contains information for introducing and/or changing the vehicle functionality; and
the central computing device is also set up to distribute the introduction data packet to a second set of vehicles of the vehicle fleet and respectively execute it there for implementation.

In other words, the vehicle ecosystem according to the invention describes a vehicle ecosystem having the ability to further develop itself. For this purpose, the vehicle ecosystem interacts with the users of the vehicle to obtain feedback from the users as to how well or badly a new development functions. Based on this feedback, the vehicle ecosystem can then automatically adapt the corresponding functionality, implement it in the vehicles and request user feedback again. This process is iterative and ensures that particularly satisfactory functionalities are developed.

Therefore, the cost and effort for the vehicle manufacturer is minimal. The vehicle manufacturer only has to maintain the hardware and software components and, if necessary, initiate development orders themselves. The actual development is automatically undertaken by the vehicle ecosystem itself.

In this case, the first set of vehicles of the vehicle fleet functions as a “test vehicle”. After new functionalities or functionalities to be changed have been satisfactorily developed in the test vehicles, these are then rolled out to the further vehicles of the vehicle fleet, i.e., to the second set of vehicles. This means that user comfort is improved, as typically not all users of the vehicles of the vehicle fleet want to participate in corresponding tests and in addition, during the course of the development, changes are also made to functionalities which worsen them and thus (temporarily during the test) impair user comfort.

According to an advantageous refinement of the vehicle ecosystem, the second set of vehicles is correspondingly larger than the first set of vehicles. Then, users who want to contribute to the further development of the vehicles can provide their vehicles as a part of the first set of vehicles and the vehicles of the remaining users form the second set of vehicles. In general, however, the second set of vehicles could also be identical in size or smaller than the first set of vehicles.

The components of the vehicles of the vehicle fleet that can be changed in their configuration are manifold. For example, a configuration includes settings parameters of vehicle subsystems. Control devices therefore use corresponding parameters for controlling vehicle components. For example, mention may be made of a degree of rigidity or suspension of the chassis, switching times of an automatic transmission, air temperature of an air conditioning system, the design of the frontend of an operating interface between vehicle occupants and an infotainment system of the vehicle, i.e., for example, the graphic design of a user interface and the underlying menu navigation, preferred settings of passenger compartment lighting, such as ambient lighting and similar. All these systems and functionalities can be configured and thus the way they function can be adapted. Similarly, new functionalities can be imported into a vehicle, such as better trained machine learning models, for example such as those used for image recognition, also known as computer vision, or as a voice dialogue system for user interaction based on speech. Road users and road signs can then be recognized more reliably with corresponding Al methods, and the intention in the voice commands of a user can be recognized more reliably. The vehicles of the vehicle fleet wirelessly receive corresponding updates from the central computing device, also referred to as “over-the-air”. For this purpose, the vehicles of the vehicle fleet can possess a telecommunications unit which, via mobile radio, has an indirect communicative connection to the central computing device via the internet. The central computing device is a cloud server, also referred to as a backend.

The development order can be initiated by the developers of the vehicle manufacturer themselves. If the vehicle manufacturer would also like to further develop a specific vehicle component, they grant a corresponding development order. The central computing device can however also initiate the development order itself, which will be discussed later.

The development data packet contains at least the interaction information and herewith describes the predefined interaction process. The interaction information serves to cause such a user interaction that enables the central computing device to collect the required information relevant to the further development of the corresponding vehicle components. For this purpose, different human-machine interfaces can be mentioned, such as microphones and loudspeakers for acoustic interaction and display devices and operating elements for visual interaction. For example, a heads-up display, a central display, the head unit, or another display in the vehicle can display questions, which the corresponding vehicle user answers. A mobile end device of the user which has a communicative connection to the vehicle can also be used for the interaction. For example, an app can be run on a smartphone, with the smartphone being coupled to the vehicle via Bluetooth.

For example, an image could be displayed to a vehicle user in a questionnaire displaying a traffic situation recorded with a vehicle camera. Then, the user could be asked what they see on the image, how the user evaluates a machine classification of the objects recognized in the image, whether the displayed image matches the surroundings in which their own vehicle is currently located, whether a played-back sound matches the represented vehicle surroundings, whether a situation recognized by a driver assistance system matches the real situation, i.e., for example, whether road signs have been correctly recognized, the vehicle is actually located on the assumed lane, free parking spaces are located to the left or right of the vehicle, there is actually a hard shoulder on a motorway, what is the quality of the road surface and, for example, whether this has been correctly classified by the driver assistance system, whether hazard warning lights have been activated in time, and similar. The user can also be given the possibility to make or propose targeted corrections to the assessment of an assistance system. Similarly, a user can be asked how well the road traffic displayed in their own vehicle matches to reality and where, if necessary, there are discrepancies. The behavior of other road users can also be evaluated to further develop, for example, a module for predicting the steering behavior of other road users.

Software changes impacting physical components of the vehicle can also be carried out, such as changing control parameters and/or storing changed characteristics. For example, the chassis can be configured according to five different degrees of rigidity, which the user then has to evaluate. Therefore, the degree of rigidity could be changed automatically, whereupon the user has to report as soon as they notice a noticeable change. An autonomous driving manner of the vehicle, such as carrying out a certain driving maneuver, for example cutting in, overtaking, braking, accelerating, cornering, parking, and similar, can be carried out and then evaluated. It can then be evaluated, for example, how comfortably the corresponding driving maneuver was carried out. The evaluation can take place using a scale, for example between one and ten and/or as a literal description. Then a user can specify that the driving maneuver was perceived as sporty, jerky, dangerous, or similar. Analogously, the infrastructure in the surroundings of the vehicle can be evaluated and/or commented on. The user can also give feedback on the user interface. For example, the user can be asked which menu navigation they find intuitive, whether prompts are too fast or too slow, whether displayed objects can be easily recognized and similar.

For example, for acoustic user interactions, the user can be asked whether the pronunciation of a voice dialogue system was understandable, the pronunciation was grammatically correct, the pronunciation was without an accent or dialect, and similar. The user can also be prompted to translate a text and to input the translation acoustically or text-based. The user can also be prompted to evaluate the quality of a machine translation. Audio files can also be transmitted to the vehicle and played back. For example, sounds classified by AI can be played back and the user has to evaluate whether the AI has correctly assigned the sound, for example a police siren. In the process, the user can also evaluate how accurate an automatic designation of the sound by a computer system is.

The components and activities listed here are only examples for improving the understanding of the vehicle ecosystem according to the invention and are not to be understood as restrictive.

With the aid of this user interaction, the vehicle ecosystem is able to find even better, i.e., more reliable and more comfortable setting values for vehicle subsystems, to train machine learning models, such as Als for example, and similar, and overall to improve the user interaction between user and vehicle. The user interaction information generated in the process is then recorded by a respective vehicle by itself and sent to the central computing device for evaluation. There, the evaluation of the user interaction information also takes place automatically, so that no effort or costs are involved for the developer of the vehicle manufacturer. Certainly, however, the developers have access to the analysis process and thus can view how the central computing device works and, if necessary, adapt the working manner of the central computing device. For example, the developers can change how the central computing device evaluates aspects, i.e., whether a certain item of feedback obtained from a user is to be classified overall as positive or negative, and the extent to which this will affect the further automated development of vehicle functionalities.

After analyzing the user interaction information and carrying out the actual component development, the central computing device creates the introduction data packet. This is then distributed to the second set of vehicles of the vehicle fleet and is implemented there. This enables the further-developed vehicle components to also be introduced into the vehicles. The second set of vehicles can therefore also be so large that all vehicles of the vehicle fleet are meant. Of course, only vehicle components or functionalities that are based on software can be configured or implemented. The functioning of physical vehicle components, which in addition to the hardware of a computing unit in the broader sense also include the mechanical components of the vehicle, is possible by adjusting control parameters in vehicle control units.

According to a further advantageous embodiment of the vehicle ecosystem, at least one subset of the vehicles of the vehicle fleet is set up to acquire usage information and to transmit this to the central computing device, wherein the usage information describes a vehicle functionality process, and the central computing device is also set up to process usage information and to analyze it to see if self-initiation of the development order is necessary if comparing an interaction result contained in the vehicle functionality process with an interaction result threshold reveals that the interaction result is lower than the interaction result threshold.

This is illustrated as follows: A voice dialogue system is mentioned representatively as a vehicle functionality. The vehicle functionality process contained by the usage information then represents the conversation held between the vehicle occupants and the voice dialogue system. This can be contained as an audio file and/or as a transcript in the digital data. An interaction result can then be understood as a vehicle occupant giving a voice command, such as for setting a specific radio station, changing the volume, activating the seat heating, changing the ventilation setting of the air conditioning system, or similar, and this being correctly understood and implemented by the voice dialogue system. The voice dialogue system might not understand the corresponding vehicle occupant. The interaction result threshold can be 80%, for example. When the voice dialogue system correctly understands the vehicle occupants in over 80% of cases and implements the command which the vehicle occupants would actually like to be executed, the interaction result is above the interaction result threshold. In comparison, if this is not the case, this means that the voice dialogue system still does not function sufficiently well. This means that the central computing device is enabled to recognize the development need to further develop the voice dialogue system. Based on this, the central computing device then initiates the development order itself. Therefore, corresponding parameters can be defined for a wide variety of vehicle components and vehicle functionalities, using the analysis of which the central computing device can evaluate whether a corresponding system is to be further developed or not.

A further advantageous embodiment of the vehicle ecosystem also provides that the central computing device has an access interface and is also set up to enable third parties to initiate a development order via the access interface, wherein the central computing device functions in this case as a mediator for deciding how far the third parties are able to intervene in the configuration of a respective vehicle. This means that the vehicle manufacturer can give third parties, such as the suppliers of the vehicle manufacturer, service providers, such as insurance companies or also other businesses or workshops, access to the vehicle, so that the respective third parties can develop their own solutions. However, data protection and cybersecurity must be complied with. Accordingly, the central computing device functions as a mediator and stipulates the rights as to how far the respective third party is allowed to intervene in the vehicle. The access interface can be realized as an API, for example, or can use such an API.

According to a further advantageous embodiment of the vehicle ecosystem, at least one subset of the vehicle of the vehicle fleet is set up to acquire vehicle characteristic information and/or user characteristic information and to transmit this to the central computing device, and the central computing device is also set up to determine the first and/or second set of vehicles of the vehicle fleet taking into account the vehicle characteristic information and/or user characteristic information. The vehicle characteristic information is the exact design of the vehicles or vehicle components. For instance, the vehicle characteristic information describes, for example, that the vehicle is a pick-up, a van, an SUV, a transporter, a semi-trailer, or similar. Further information concerns the exact design of the vehicles, i.e., for example, which special equipment is installed, which power the drive engine of the vehicle has, whether an electric drive motor and/or an internal combustion engine is installed, whether it is a cabriolet, and similar. Certain development orders only concern certain vehicle components or are only suited for a restricted vehicle design. Taking into account the vehicle characteristic information, the central computing device can respectively determine the first and/or second set of vehicles, such that in each case the development orders are distributed to the matching vehicles. If, for example, camera images of the vehicle's surroundings have to be recorded using vehicle cameras as part of a development process and these images have to be analyzed using machine learning methods, the corresponding development orders and development data packets are only distributed to those vehicles that also have said cameras.

In addition to the exact design of the vehicles, information relating to a user can also be relevant for deciding to whom the respective development orders are distributed. User characteristic information includes, for example, demographic information such as age, gender, origin and the like, place of residence, income, hobbies, average distance travelled per month, driving style, marital status, number of children and the like. For example, certain vehicle functionalities can be evaluated differently by different users. If information describing a user is taken into account, a particularly differentiated evaluation by the central computing device is possible. Thus, for example, the person driving the vehicle having a sport driving manner is more likely to prefer firm suspension than a driver who places a lot of value on comfort. Other development orders, for example, are only relevant for those journeys or vehicle uses, in which children are travelling in the vehicle. Accordingly, these development orders are only distributed to those vehicles in which children regularly travel. For some development orders, it can also be necessary that several vehicle occupants interact together in the vehicle and, for example, fill in a survey as a group. Particularly for children, such a survey can also be designed as a video game, using aspects of gamification.

The central computing device can therefore weight the user characteristic information transmitted by the users of the vehicles of the vehicle fleet using different criteria. For instance, different users can be more or less credible. This means that information when answering surveys has been given correctly. Thus, for example, the user characteristic information can contain such a credibility factor. Accordingly, the inputs of users with a high credibility factor are given heavier weighting. The weighting can, however, also be based on other information.

A further advantageous embodiment of the vehicle ecosystem also provides that the central computing device is also set up to receive readiness time information which describes at which times a respective vehicle user is available for using their vehicle, in order to determine the first set of vehicles of the vehicle fleet taking into account the readiness time information. Therefore, the level of comfort for the vehicle user can be further increased. A vehicle user can fill out a corresponding survey, for example, on a mobile end device, such as a smartphone, a tablet, a laptop, or also on a desktop computer. They can do this when they have a quiet minute at home. Particularly advantageously, however, the user interaction takes place in the vehicle during vehicle usage. This can prevent the vehicle occupants from becoming bored, and additionally the vehicle components to be evaluated can be experienced directly, which enables direct feedback to be given. Therefore, the central computing device requires information regarding at which times a respective user uses their vehicle. This readiness time information, i.e., the information regarding at which date and at which time the respective user uses their vehicle, can be directly transmitted to the central computing device. For example, a vehicle user can inform the central computing device via their mobile end device or also via the infotainment system of the vehicle on which days and at what times they will travel with the vehicle. For this purpose, for example, this also includes the daily commute to work. The central computing device or the vehicles themselves using vehicle-internal computing units can also recognize corresponding travelling patterns themselves.

In the simplest case, the vehicles of the vehicle fleet transmit the start of a readiness time frame when the drive engine of a respective vehicle is started. Accordingly, the readiness time frame ends when the drive engine is manually switched off.

According to a further advantageous embodiment of the vehicle ecosystem, at least one subset of the vehicles of the vehicle fleet is set up to transmit route information to the central computing device and the central computing device is also set up to process the route information for determining the readiness time information. If, for example, a travel route is input into a navigation system, the vehicle can independently determine that there is a readiness time frame during the travelling period along the navigation route.

A further embodiment of the vehicle ecosystem according to the invention also provides that the central computing device is also set up to provide an individual incentive account to the individual vehicle users and to credit incentive credit to a respective incentive account when the respective vehicle user as part of the first set of the vehicles of the vehicle fleet provides user interaction information to the central computing device. In other words, the vehicle users who are involved in the further development of the vehicle components are remunerated. For example, money, vouchers or also an extended usage period of subscribed vehicle functionalities can be credited to the corresponding incentive account as incentive credit. Then, money can be transferred to a respective vehicle user, for example, to a bank account. Vouchers can be redeemed for example in an authorized workshop for carrying out maintenance or repairs. Specific vehicle functionalities, such as, for example, providing heated seats or providing increased driving power, can be subscribed to and, for example, can be used for a time period, such as a year. If the time period expires, the functionality is not available anymore. Then, for example, an extended month of the functionality usage can be provided as incentive credit. This means that the motivation of the vehicle user to provide corresponding user interaction information is increased. This increases the reliability that the vehicle ecosystem can also further develop itself.

Preferably, the vehicles of the vehicle fleet are set up to provide a secure environment for executing a development data packet, wherein the access to vehicle resources is restricted in the secure environment in comparison to normal operation. This means that in particular the cybersecurity is improved. For example, virtual machines in which the corresponding development packets are executed can be executed on a computing unit of the vehicle. Also, the extent to which a computing unit can use vehicle functionalities can be restricted. In particular when third parties grant development orders, this means that unauthorized tapping of data or manipulation of security-relevant configuration parameters are prevented.

The entities of the vehicle ecosystem, i.e., the central computing device and the vehicles of the vehicle fleet, are not only set up to provide the approach described above, but also to execute this. According to the invention, a method for a vehicle ecosystem is thus described, through the application of which the vehicle ecosystem is enabled to further develop independently.

Further advantageous embodiments of the vehicle ecosystem according to the invention result from the exemplary embodiment which is described in more detail below with reference to the figure.

### BRIEF DESCRIPTION OF THE SOLE DRAWING FIGURE

The sole drawing figure shows a schematic view of a vehicle ecosystem according to the invention.

### DETAILED DESCRIPTION

The sole figure illustrates a central computing device 1 and plurality of vehicles 2 forming a vehicle ecosystem 3 according to the invention. The vehicle ecosystem 3 according to the invention possesses the possibility to develop independently.

For this purpose, the central computing device 1 distributes a development data packet to a first set 4.1 of vehicles 2 of the shown vehicle fleet. The development data packet contains interaction information and optionally configuration information. The interaction information describes a predefined interaction process with vehicle occupants. The configuration information provides for introducing and/or changing an existing software-based vehicle functionality in a respective vehicle 2.

The vehicle occupants or vehicle users of the vehicles 2 of the first set 4.1 of the vehicle fleet enter feedback about the vehicle component to be further developed in accordance with the predefined interaction process. The vehicles 2 or the computing units installed there collect the user feedback in the form of user interaction information and transmit this back to the central computing unit 1. There, the user interaction information is evaluated, whereupon the central computing device 1 creates an introduction data packet. The introduction data packet contains the settings or newly developed or adapted algorithms and/or machine learning models that have been positively evaluated by the individual vehicle users. The introduction data packet is then distributed to a second set 4.2 of vehicles 2 of the vehicle fleet. The first set 4.1 and the second set 4.2 can differ or also be identical. The second set 4.2 can be smaller, equal in size or preferably larger than the first set 4.1. In addition, depending on the design of the development data packet, individual vehicles 2 may not be part of any set 4.1, 4.2.

The central computing device 1 can itself decide, depending on the situation, which vehicles 2 belong to the first and/or second set 4.1, 4.2. For this purpose, the central computing device 1 takes into account vehicle characteristic information and/or user characteristic information.

Optionally, third parties 5 can be a part of the vehicle ecosystem 3. In this case, for example, these are suppliers of a vehicle manufacturer, workshops, a developer of navigation software, and similar. This means that the third party 5 is given the possibility to use the vehicle ecosystem 3 according to the invention, in order to advance their own developments in the automotive field. The operator of the central computing device 1, for example the vehicle manufacturer, can request a fee from the third party 5, in order for the latter to be able to access the described infrastructure of the vehicles 2.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-9. (canceled)

10. A vehicle ecosystem comprising:
a central computing device; and
a vehicle fleet, wherein vehicles of the vehicle fleet are in bidirectional communication with the central computing device and are configured such that a configuration of the vehicle is changeable by receiving information from the central computing device,
wherein the central computing device is configured to
obtain a development order or initiate the development order, wherein the development order at least describes which vehicle component is to be further developed,
create a development data packet based on the development order and distribute the development data packet to a first set of vehicles of the vehicle fleet, wherein the development data packet at least comprises interaction information, wherein the interaction information describes a predefined interaction process with vehicle occupants via a human-machine interface,
control the first set of vehicles of the vehicle fleet to execute the development data packet, wherein at least one vehicle functionality and the predefined interaction process are executed in each of the vehicles of the vehicle fleet based on the interaction information, wherein the vehicles are configured to record user interaction information obtained during the predefined interaction process and to transmit the recorded user interaction information to the central computing device,
process the recorded user interaction information obtained from the first set of vehicles of the vehicle fleet and create an introduction data packet based on knowledge gained from the recorded user interaction information obtained from the first set of vehicles of the vehicle fleet, wherein the introduction data packet contains information for introducing or changing the vehicle functionality, and
distribute the introduction data packet to a second set of vehicles of the vehicle fleet and respectively execute the introduction data packet by the second set of vehicles,
wherein at least one subset of the vehicles of the vehicle fleet is configured to acquire usage information and to transmit the usage information to the central computing device, wherein the usage information describes a vehicle functionality process, and the central computing device is also configured to process the usage information and to analyze the usage information to see that self-initiation of the development order is necessary when comparing an interaction result contained in the vehicle functionality process with an interaction result threshold reveals that the interaction result is lower than the interaction result threshold.

11. The vehicle ecosystem of claim 10, wherein the second set of vehicles is larger than the first set of vehicles.

12. The vehicle ecosystem of claim 10, wherein the central computing device has an access interface and is configured to enable third parties to initiate a development order via the access interface so that the central computing device functions as a mediator for deciding how far the third parties are able to intervene in the configuration of a respective vehicle.

13. The vehicle ecosystem of claim 10, wherein at least one subset of the vehicles of the vehicle fleet is configured to acquire vehicle characteristic information or user characteristic information and to transmit the acquired vehicle characteristic information or user characteristic information to the central computing device, and the central computing device is also configured to determine the first or second set of vehicles of the vehicle fleet taking into account the vehicle characteristic information or user characteristic information.

14. The vehicle ecosystem of claim 13, wherein the central computing device is also configured to receive readiness time information describing at which times a respective vehicle user is available for using their vehicle to determine the first set of vehicles of the vehicle fleet taking into account the readiness time information.

15. The vehicle ecosystem of claim 14, wherein at least one subset of the vehicles of the vehicle fleet is configured to transmit route information to the central computing device and the central computing device is also configured to process the route information to determine the readiness time information.

16. The vehicle ecosystem of claim 10, wherein the central computing device is configured to provide an individual incentive account to individual vehicle users and to credit incentive credit to a respective incentive account when the respective vehicle user as part of the first set of vehicles of the vehicle fleet provides user interaction information to the central computing device.

17. The vehicle ecosystem of claim 10, wherein the vehicles of the vehicle fleet are configured to provide a secure environment to execute a development data packet, wherein access to vehicle resources is restricted in the secure environment in comparison to normal operation.

18. The vehicle ecosystem of claim 10, wherein the development data packet further comprises configuration information, wherein the configuration information contains information for introducing a new and/or for changing an existing vehicle functionality that is based on software, wherein at least one vehicle configuration concerning the vehicle functionality is changed based on the configuration information.

19. A method comprising:
establishing a bidirectional communication between vehicles of a vehicle fleet and a central computing device, wherein the vehicles of the vehicle fleet are configured such that a configuration of the vehicle is changeable by receiving information from the central computing device;
obtaining, by the central computing device, a development order or initiate the development order, wherein the development order at least describes which vehicle component is to be further developed;
creating, central computing device, a development data packet based on the development order and distribute the development data packet to a first set of vehicles of the vehicle fleet, wherein the development data packet at least comprises interaction information, wherein the interaction information describes a predefined interaction process with vehicle occupants via a human-machine interface;
controlling, central computing device, the first set of vehicles of the vehicle fleet to execute the development data packet, wherein at least one vehicle functionality and the predefined interaction process are executed in each of the vehicles of the vehicle fleet based on the interaction information, wherein the vehicles are configured to record user interaction information obtained during the predefined interaction process and to transmit the recorded user interaction information to the central computing device;
processing, central computing device, the recorded user interaction information obtained from the first set of vehicles of the vehicle fleet and create an introduction data packet based on knowledge gained from the recorded user interaction information obtained from the first set of vehicles of the vehicle fleet, wherein the introduction data packet contains information for introducing or changing the vehicle functionality; and
distributing, central computing device, the introduction data packet to a second set of vehicles of the vehicle fleet and respectively execute the introduction data packet by the second set of vehicles,
wherein at least one subset of the vehicles of the vehicle fleet is configured to acquire usage information and to transmit the usage information to the central computing device, wherein the usage information describes a vehicle functionality process, and the central computing device is also configured to process the usage information and to analyze the usage information to see that self-initiation of the development order is necessary when comparing an interaction result contained in the vehicle functionality process with an interaction result threshold reveals that the interaction result is lower than the interaction result threshold.
